(19) United States
(12) Patent Application Publication
(10) Pub. No.: US 2004/0078240 A1
(43) Pub. Date: Apr. 22, 2004

(54) Method and apparatus for capturing and analyzing individual patient clinical data

(76) Inventor: Michael S. Katz, Bayside, NY (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/661,557

(22) Filed: Sep. 15, 2003

Related U.S. Application Data
(60) Provisional application No. 60/410,306, filed on Sep. 13, 2002.

(51) Int. Cl. G06F 17/60

(52) U.S. Cl. 705/3

(57) ABSTRACT

A method and apparatus that allows patients with basic computer skills and minimal medical vocabulary to build a cumulative record of their clinical data over time and to prepare tabular and graphic reports that provide a clear view of trends related to their treatment. When performing flow sheet activities such as entering data and/or viewing tabular test data, test descriptions remind the patient of the purpose and/or significance of the respective tests. Test result values that exceed minimum or maximum values specified for each test are automatically marked so that the patient is alerted to the out of range values. Patients are able to produce customized tabular and/or graphic reports for patient selected test results in a patient specified presentation order. Updateable links to locally stored and/or Internet accessible information allows patients to remain fully informed of support group activities and advances courses of treatment for their disease.

### CROSS-REFERENCE TO RELATED APPLICATIONS

This application claims priority from U.S. Provisional Patent Application Serial No. 60/410,306, entitled “Automated FlowSheet For Capturing, Analyzing, Printing and Charting Clinical Data On Individual Patients” and filed Sep. 13, 2002, the disclosure of which is incorporated herein by reference in its entirety.

### BACKGROUND OF THE INVENTION

1. Field of the Invention

The present invention pertains to the analysis of patient clinical data. In particular, the present invention pertains to a personal organizer used by a patient to store and view personal clinical data.

2. Discussion of the Related Art

Patients battling cancers such as multiple myeloma, where treatment and monitoring may extend over an extended period of time, have a clear need to track clinical results and monitor trends over time. Lab reports and medical charts, for example, will typically present results from batteries of tests performed on a single date, however, during a course of treatment a patient is likely to undergo multiple batteries of tests. Analysis of trends across multiple batteries of tests often proves a daunting task for patients who want to take an active role in monitoring their treatment.

Although systems exist in the prior art that address the retrieval and analysis of patient clinical data, such systems are typically focused upon the needs of health care providers (i.e., doctors offices, laboratories) and/or require a complex technical support infrastructure (e.g., complex databases, connectivity to multiple remote data sources, etc.) and/or specialized knowledge that is not available to an individual patient interested in viewing trends in the patient's own personal medical treatment. In addition, patients typically have limited computer experience/skills and would, therefore, be unable to make use of systems tailored to the needs of technically trained patients.

Patients typically have little or no medical training or medical experience. Given the number and types of tests performed, patients typically have difficulty remembering the purpose for which a specific test (or series of tests) is performed, the significance of individual test result values and/or the significance of trends in the test result data over time. Therefore, even though patients regularly receive copies of individual laboratory results from their doctors, the patients are unable to take an active interest in the results of the tests and remain less informed regarding their condition than patients would otherwise be if they were able to fully track and understand the test results. As a result, patients are less informed about the progress of their disease and are less able to make informed, timely decisions regarding their treatment.

Many serious ailments, such as multiple myeloma, are the focus of ongoing research that results in the development of new treatments and new medicines on a regular basis. In addition, such ailments are typically the focus of support groups that publish advice and plan events that are of interest to patients. Patients are often unaware of the wealth of knowledge and support that is available to them regarding their disease. Patients typically do not make use of such resources because they are unaware of the existence or applicability of such support groups and/or information, or their applicability to the personal medical issues that they face.

Hence, a need remains for a patient test results organizer that allows a patient with limited computer knowledge and no medical training or specialized medical knowledge to enter and track test results generated by repeated medical tests performed during the course of the patient's treatment. Preferably, such a test results organizer would allow the patient to track the purpose of individual tests, facilitate the identification of medically significant test results, and provide access to information sources that are likely to be of interest to the patient based upon the tests that are being performed and/or test results received. The organizer would also allow the patient to produce hard copy reports and charts that can be used as a basis for discussion of the patient's situation with health care providers, support groups and others.

### OBJECTS AND SUMMARY OF THE INVENTION

Therefore, in light of the above, and for other reasons that may become apparent when the invention is fully described, an object of the present invention is to organize patient medical test results in a manner that is easily reviewed by the patient.

Another object of the present invention is to identify test result values that are of medical significance and/or identify test result errors and provide hard copy reports and charts that can be used to discuss these results with health care providers, support groups and other appropriate resources. Yet another object of the present invention is to identify the purpose of individual tests and to clarify the significance of high values, low values and/or significant changes in the values over time.

Still another object of the present invention is to eliminate the need for significant computer knowledge, medical knowledge, or technical knowledge on the part of a patient in order for the patient to enter, organize, and meaningfully review the patient's test result data and trends in the test result data.

A further object of the present invention is to facilitate access to information and organizational resources that are likely to be of interest to a patient.

The aforesaid objects are achieved individually and in combination, and it is not intended that the present invention be construed as requiring two or more of the objects to be combined unless expressly required by the claims attached hereto.

According to the present invention, a method and apparatus is provided that allows patients with basic computer skills and minimal medical vocabulary to build a cumulative record of their clinical data over time and to prepare tabular and graphic reports that provide a clear view of trends.

The organizer can be pre-loaded with common test types generally employed for their disease, with related tests grouped by common test types (e.g., blood counts, kidney function.) A patient is able to define additional tests and group related tests together by assigning related tests to a common test type. Descriptive text can be associated with each test type as well as each individual test. High and low test result values can be specified for each test. When viewing tabular test data, a patient is able access test type/test descriptions via pop-up windows, so that the patient can be reminded of the purpose or significance of the test when viewing the data. Patients enter test results by clicking on tabular data, which activates a popup that provides prompts for the full battery of tests being tracked for a specific date or allows revision of any result previously entered. Test result values that exceed minimum or maximum values specified for the test are automatically marked so that the patient is alerted to the out of range values.

Patients are able to produce customized tabular and/or graphic reports based upon the results received for one or more selected tests. A set of specific medical tests can be selected for inclusion in a generated report by selecting one or more test types and selecting one or more tests within each selected test type. Data for a selected set of types/tests can be restricted to a common range of dates during which the respective medical tests were performed or individual date ranges can be specified for one or more of the selected tests.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a process workflow depicting use of a patient clinical test results flow sheet.

FIG. 2 is a blank patient flow sheet screen prior to the inclusion of patient test data.

FIG. 3 is a flow sheet specific drop-down menu added to the standard Excel menu bar

FIG. 4 is pop-up window used to personalize a flow sheet with the patient's name.

FIG. 5 is pop-up window used to select tests for inclusion in a flow sheet based upon test type and/or test name.

FIG. 6 is a pop-up window used to define a new medical test.

FIG. 7 is a pop-up window used to define a new medical test type.

FIG. 8 is a pop-up window used to edit a defined test.

FIG. 9 is a pop-up window used to specify a date upon which a battery of tests was performed.

FIG. 10 is a pop-up window used to enter data into defined tests base upon test name or test type.

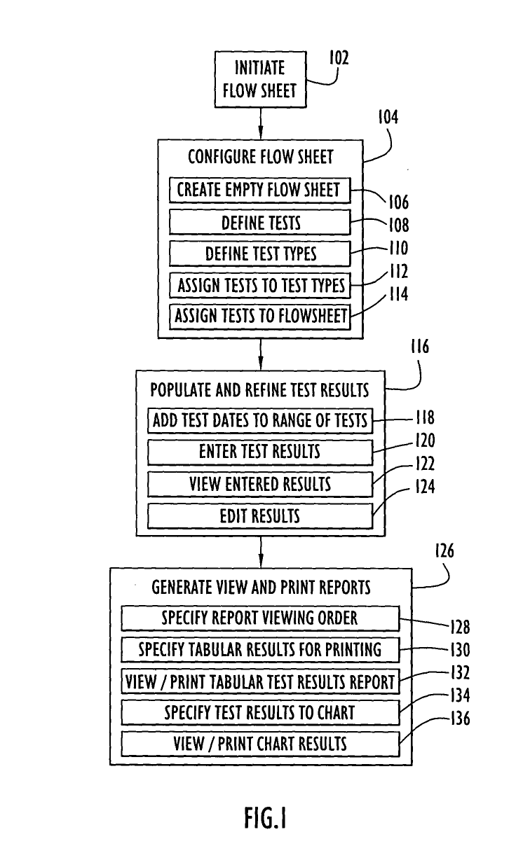

FIG. 1I is a flow sheet that has been populated with defined tests and test data.

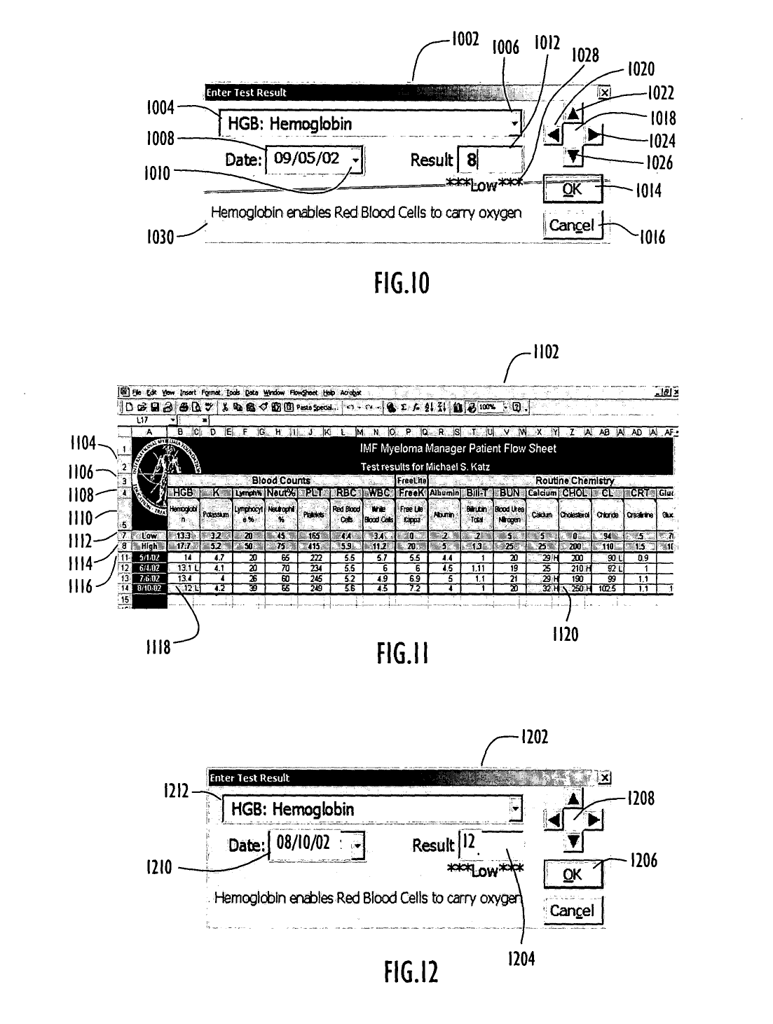

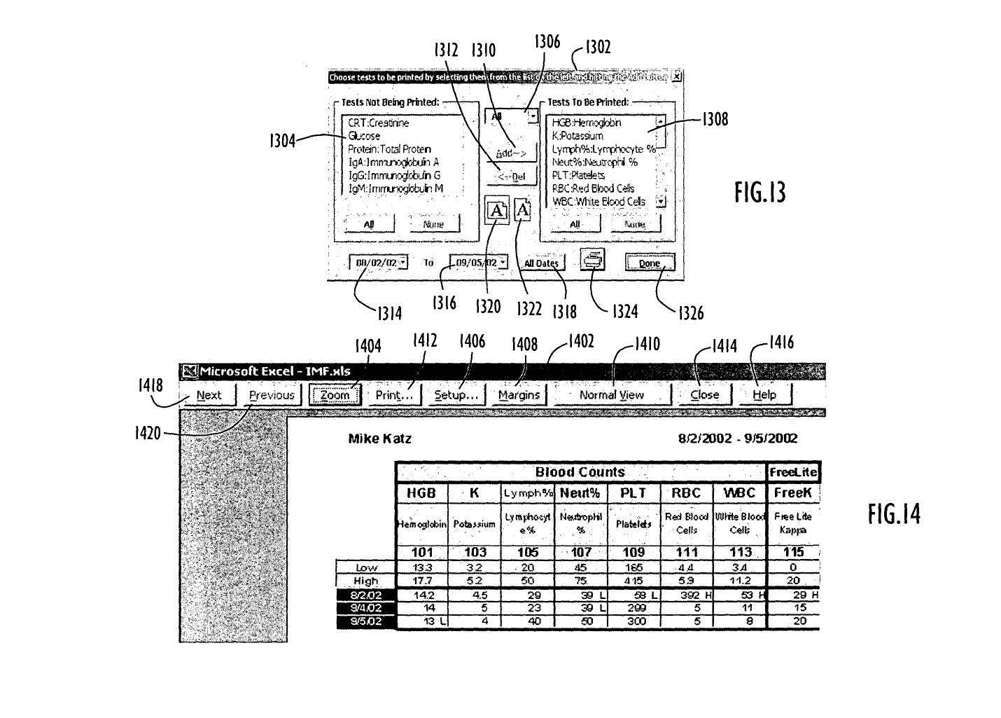

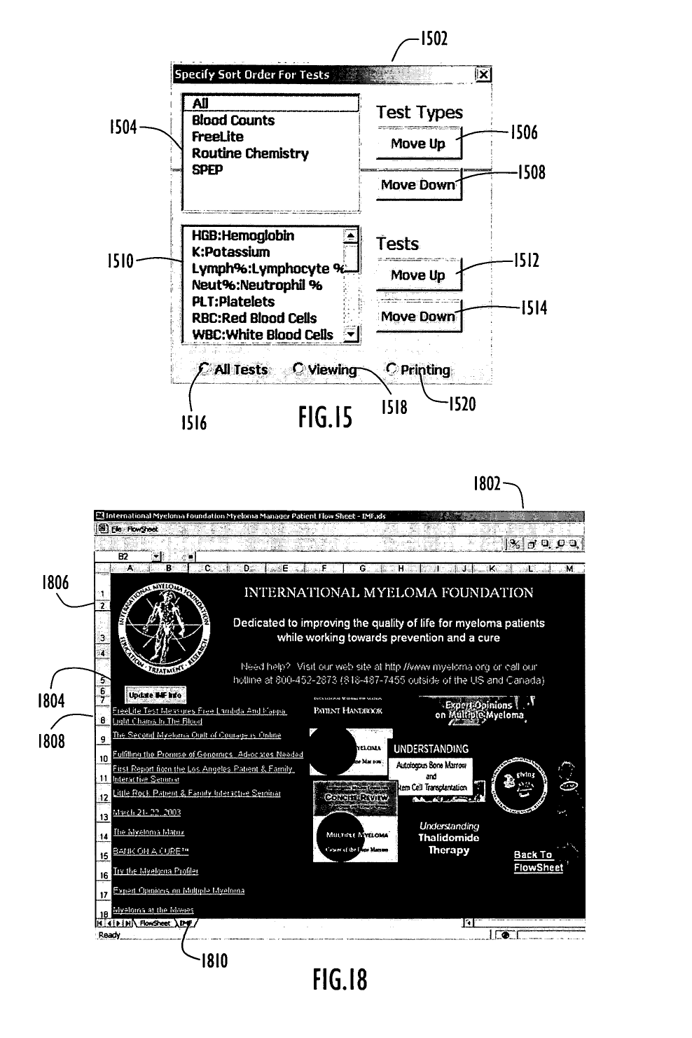

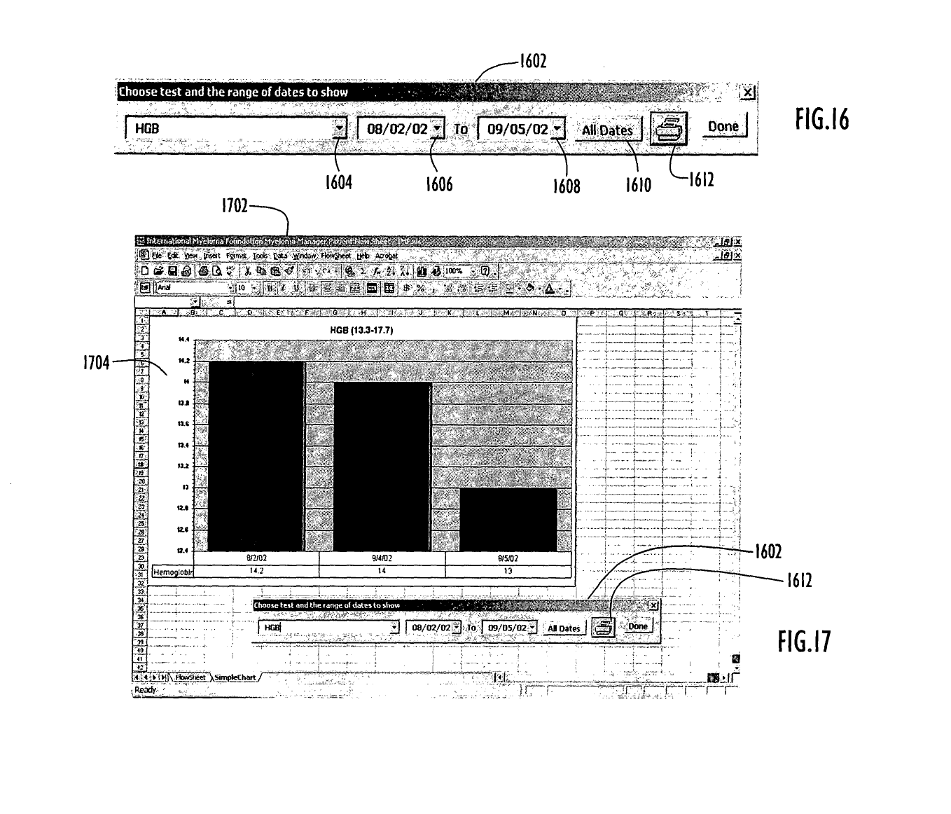

FIG. 12 is the pop-up window of FIG. 9, invoked via the flow sheet of FIG. 10 to edit data.

FIG. 13 is a pop-up window used to select test for printing a tabular report.

FIG. 14 is a print-preview of a generated tabular report.

FIG. 15 is a pop-up window used to specify an order in which generated reports are to be presented.

FIG. 16 is a pop-up window used to select a test for generating a chart report.

FIG. 17 is a generated chart report.

FIG. 18 presents representative medical related links.

### DETAILED DESCRIPTION OF THE PREFERRED EMBODIMENTS

A representative process workflow use to configure and use a patient clinical test results flow sheet to organize and review patient clinical test results data is presented in FIG. 1, by way of example. Using a flow sheet, as described here, patients with minimal computer literacy can maintain a comprehensive database of clinical data and prepare elaborate and attractively-formatted tabular printouts and charts that are extremely helpful for both personal use, for doctor/patient discussions and for inclusion in medical records.

In a preferred embodiment, a patient clinical test results flow sheet, or flow sheet, is implemented in a Microsoft Excel Workbook, capable of being executed on any computer that can execute Microsoft Excel 2000, or later release. In such a preferred embodiment, flow sheet specific dropdown menus, pop-up windows, dialog boxes, and automated processing are implemented using the Visual Basic for Applications programming language.

The flow sheet workbook is preferably protected from direct editing by a patient. All inputs and changes are accomplished via menus and pop-up windows controlled by Visual Basic for Applications based procedures that are inaccessible to the patient. Custom context sensitive menus and dynamic pop-up window controls are used to guide a patient through a logical sequence of steps for building and using a patient clinical test results flow sheet in accordance with the present invention. For example, menu and pop-up window options are enabled or disabled and dynamic messages displayed or removed based upon context. Patients are directed to the next logical step in the flow sheet process by enabling only the options that are applicable based on the current content of the flow sheet workbook.

As shown in FIG. 1, once a patient flow sheet is initiated, at 102, use of the patient flow sheet to organize and analyze patient test results includes three primary phases: configuring a flow sheet, at step 104; populating and refining the data content of a flow sheet, at step 116; and, generating, viewing and printing flow sheet tabular and graphical reports, at step 126.

Configuring a flow sheet, at step 104, includes: creating, at step 106, an empty flow sheet; defining, at step 108, a set of tests; defining, at step 110, a set of test types; assigning, at step 112, one or more tests defined at step 108 to a test type defined at step 110; and, finally, assigning, at step 114, defined tests to the flow sheet.

Populating and refining the data content of a flow sheet, at step 116, includes: adding, at step 118, a test date across the range of tests previously assigned to the flow sheet; entering, at step 120, tests results for tests assigned to the worksheet performed on a test date added to the range of assigned tests; viewing, at step 122, flow sheet test result entries, with particular review emphasis upon values that the flow sheet has automatically identified as out of range; and, editing, at step 124, flow sheet data entries that have been found to be in error.

Generating, viewing and printing flow sheet tabular and graphical reports, at step 126, includes: specifying, at step 128, a report viewing order that determines the order in which generated reports are presented; identifying, at step 130, a set of tests for which tabular reports are to be generated; generating/viewing/printing, at step 132, the specified set of tabular reports; identifying, at step 134, a set of tests for which graphical reports are to be generated; and, generating/viewing/printing, at step 136, the specified set of tabular reports.

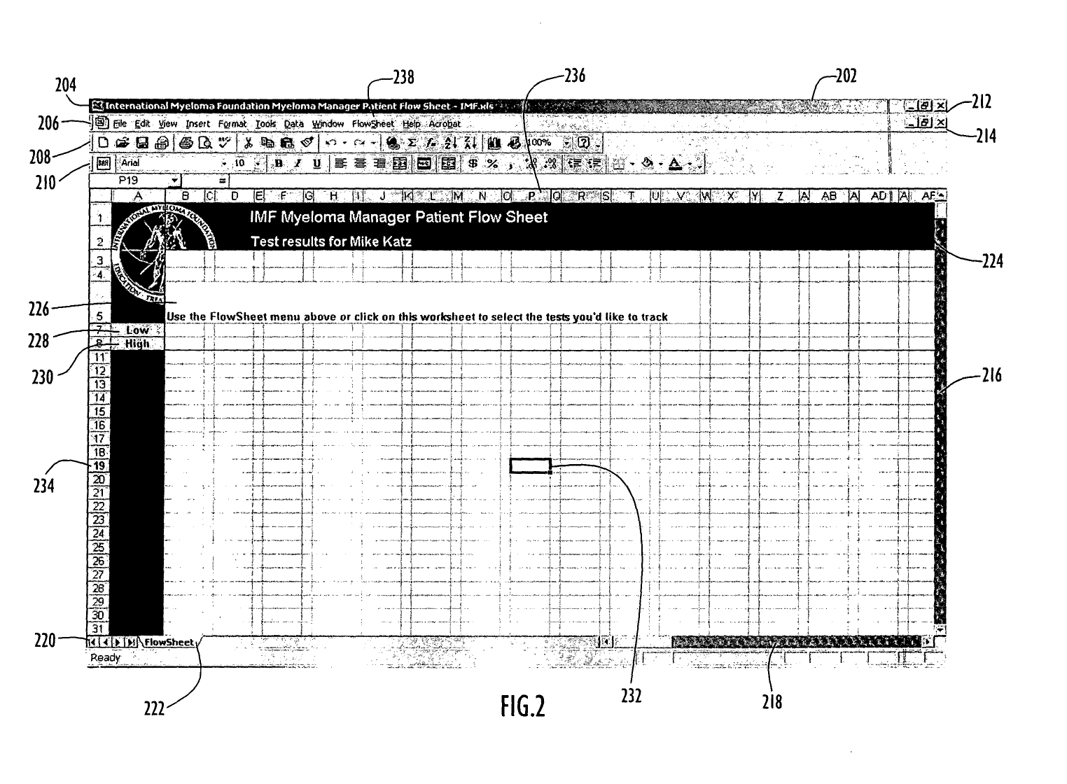

FIG. 2 illustrates, by way of example, a cleared patient flow sheet, as would be presented to a patient upon opening a new flow sheet workbook within Microsoft Excel, or upon clearing a flow sheet, as described below. A flow sheet workbook, in accordance with the preferred embodiment of the present invention, tailors the Microsoft Excel operating environment to support patient flow sheet activities. Features retained from a traditional Microsoft Excel workbook include: a flow sheet title bar 204 used to name the flow sheet, a menu bar 206 that presents a series of drop-down menus, and tool bars 208 and 210, which include icons for performing common Excel workbook functions. Also included is a conventional button 212 used to shrink the entire Excel program and conventional button 214 used to shrink or minimize the individual workbook, a conventional vertical slide 216, a conventional horizontal slide 218, a workbook worksheet tab control 220 and individual worksheet tab 222.

Features of the work flow workbook that are tailored specifically for the patient flow sheet of the present invention are the flow sheet title 224, guidance messages (an example of which is shown at 226), and high and low values associated with each define patient test, as shown at 228 and 230, respectively, that are used to store high-low values for individual test results assigned to the patient flow sheet, as described below. The patient flow sheet includes a plurality of cells, an example of which is shown at 232. Each cell is specified with a row/column combination. As indicated in FIG. 2, cell 232 is associated with row nineteen (at 234) and column P (at 236). Further, menu bar 206, is supplemented with a patient flow sheet dynamic drop-down menu bar 238.

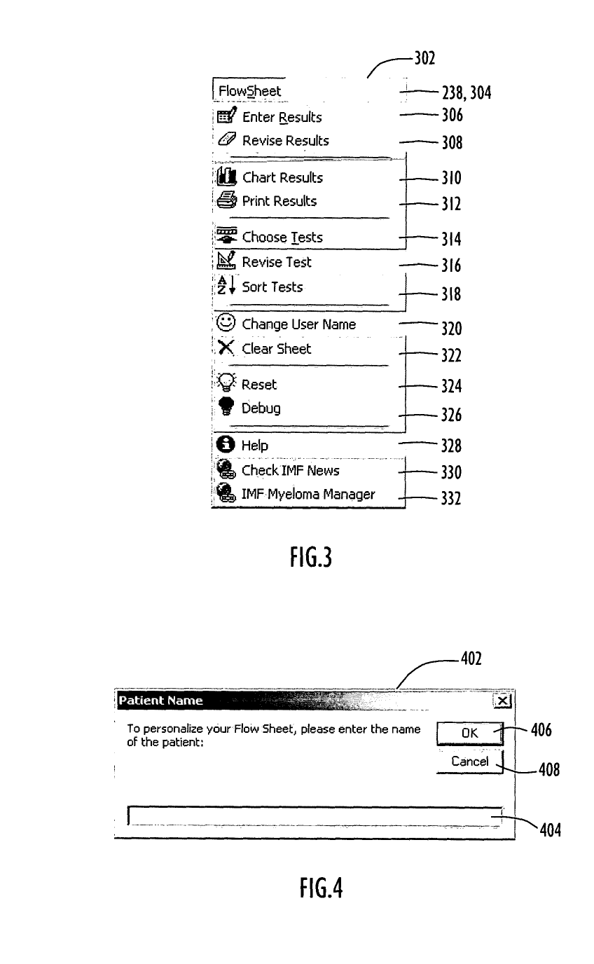

FIG. 3 illustrates, by way of example, a representative, dynamic, drop-down menu 302 that is presented upon clicking the menu bar 238/304 described with respect to FIG. 2. Upon clicking drop-down menu bar 238/304, a drop-down menu is presented. The drop-down menu bar items identified in FIG. 3 at 306 through 332 are activities that can be performed within the patient flow sheet. The menu bar items are dynamically activated or deactivated based upon the current status of the patient flow sheet. For example, menu bar item “enter results” 306 and “revise results” 308 have been deactivated, while menu bar item “choose tests” 314 and “sort tests” 318 are activated. Specific details regarding individual activities that are initiated from the flow sheet drop-down menu are described below. References back to the respective menu bar item presented in FIG. 3 will be included, as appropriate.

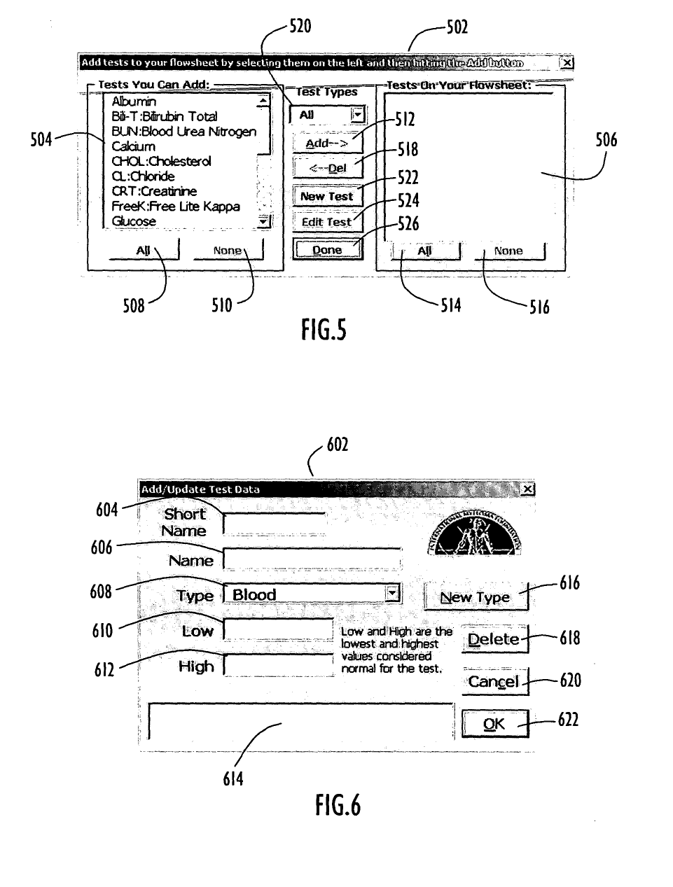

FIG. 4 illustrates, by way of example, a Patient Name pop-up window 402 that is used to personalize the flow sheet to an individual patient. This pop-up window is initiated by clicking on the “change user name” 320 drop-down menu item presented in FIG. 3. The patient enters his name at 404 and when satisfied with the name, clicks on “OK” button 406 to save the change or “Cancel” button 408 to exit the patient name pop-up window without saving changes.

FIG. 5 illustrates, by way of example, an Add Tests pop-up window 502 that is used to define and select tests for association with a patient flow sheet. Add tests pop-up window 502 is initiated by clicking on the “choose tests” drop-down menu item 314 presented in FIG. 3. Using add tests pop-up window 502, defined tests listed in selection window 504 are selected for inclusion in the patient flow sheet. For example, by selecting one or more tests from window 504 and clicking on add button 512, the selected test will be moved from selection window 504 to selection window 506, indicating that the tests are now associated with the flow sheet. Although add button 512 is indicated as deactivated in FIG. 5, upon selecting tests in window 504, the add button 512 is activated. Tests are selected for adding to the flow sheet by clicking upon individual tests in window 504 or selecting all tests by clicking upon all button 508. A selected test can be de-selected, prior to transfer to window 506, by clicking again upon a previously selected test. Alternatively, all selected tests can be deselected by clicking the none button at 510. Although none button 510 in FIG. 5 is indicated as deactivated, upon selecting one or more tests from window 504, none button 510 is activated. To remove tests previously added to window 506, a patient selects one or more tests from window 506 and clicks delete button 518 to return the selected tests to window 504. A patient can select all tests in window 506 by clicking all button 514 or deselecting all selected tests in window 506 by clicking none button 516. Although delete button 518 is indicated as deactivated, upon selecting one or more tests from window 506, delete button 518 is activated.

Add tests pop-up window 502 can also be used to define new tests and to edit previously defined tests. Defined tests presented for selection in window 504 are determined based upon test type indicated in selection box 520. Using selection box 520, a patient can present “all” test types in window 504 or tests associated with only a specific test type. Further, the definition of a test can be edited by selecting a test in window 504 and clicking edit test button 524, which will then be active. A new test can be generated by clicking on new test button 522.

FIG. 6 illustrates, by way of example, an add test/update test pop-up window that is used to define new tests and/or to edit previously defined tests. An empty add test/update test pop-up window, as shown at 602, is initiated by selecting the new test button 522 as described with respect to FIG. 5. A new test is defined by adding a short name at 604, a full name at 606, associating the test with a test type via selection box 608 and providing a low test result value at 610 and a high test result value at 612. These values are considered the lowest and highest values considered normal for the test and are used for flagging test result values of interest to the patient. Comments or description to be associated with the test can be typed into text box 614. Once the patient is satisfied with the entries added to the add test pop-up window, the patient may select “OK” button 622 to add the test. Once added, a new test will be automatically presented via other flow sheet pop-up windows, such as the select test pop-up window 504 described with respect to FIG. 5. If the patient wishes to remove a test or cancel current add test activities, the patient may click upon delete button 618 or cancel button 620, respectively. A new test type that can be used to associate defined tests with a common test type can be defined by the patient by clicking on new type button 616.

FIG. 7 illustrates, by way of example, a defined new test type pop-up window 702 that is initiated by clicking on new type button 616 shown in FIG. 6. To add a new test type, the patient enters a new test type in text box 704 and clicks upon the add button 706 which will then be activated. To delete a test, the patient selects a test from selection box 708 and clicks upon delete button 710 which will then be activated. When finished, the patient can exit the define test type pop-up window by clicking upon cancel button 712 or done button 714.

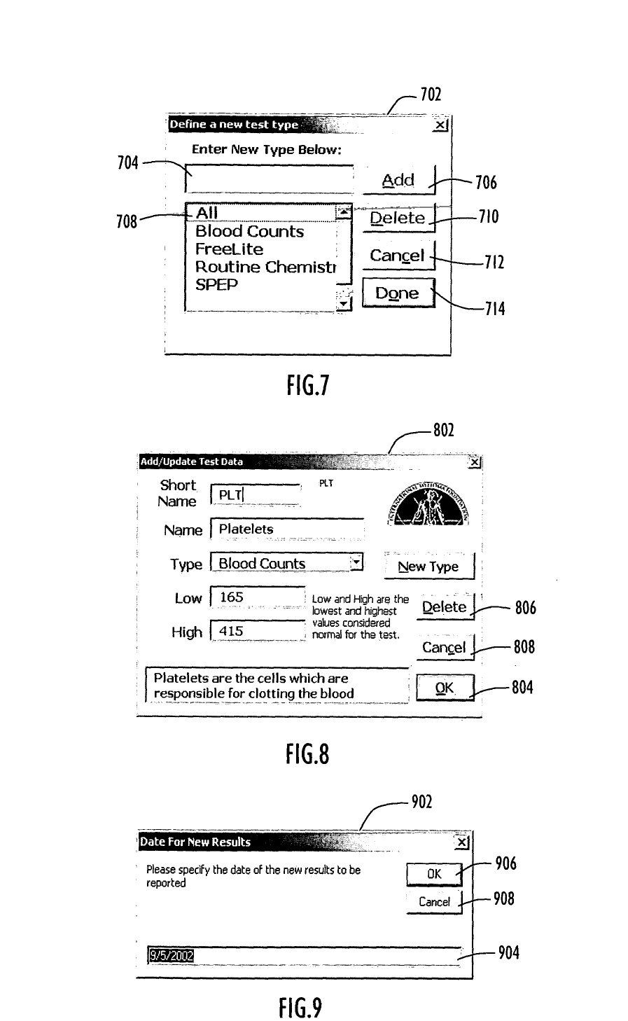

FIG. 8 again illustrates, by way of example, the add test/update test pop-up window first described with respect to FIG. 6. However, the pop-up window presented in FIG. 8 is initiated by first selecting a test from window 504 (within Add Tests pop-up window 502 described with respect to FIG. 5) and clicking upon edit test button 524. The functions presented in FIG. 8 are the same functions described with respect to FIG. 6. Upon editing the fields as desired, the patient may save the changes by clicking “OK” button 804, or canceling entered changes by clicking cancel button 808. Further, a test can be deleted by clicking delete button at 806.

As tests are defined and selected for inclusion in a patient flow sheet, the test is added to the cleared patient flow sheet presented in FIG. 2. However, before test result data may be entered into the flow sheet in association with the defined tests associated with the patient flow sheet, a test date must first be added to the battery of defined tests that the patient has associated with the patient flow sheet.

FIG. 9 illustrates, by way of example, New Date pop-up window 902 for adding a date to a battery of tests associated with a patient flow sheet. A patient New Date pop-up window 902 is initiated by clicking on the “enter results” 306 drop-down menu item presented in FIG. 3. The patient enters a date upon which a battery of tests were performed in text box 904 and clicks “OK” button 906 to save the test date and to add the test date to the battery of tests associated with the patient flow sheet. Alternatively, the patient can cancel the new date by clicking cancel button 908.

FIG. 10 illustrates, by way of example, an Enter Test results pop-up window 1002 that is initiated upon first adding a date, as described with respect to FIG. 9, or by clicking on the “enter results” 306 drop-down menu item presented in FIG. 3 after having previously defined one of more test dates, as described above with respect to FIG. 9. Alternatively, an Enter Test results pop-up window 1002 can be initiated by clicking any results cell (e.g., 1120), which will preselect the date and test based on the cell that was clicked. If there is no date specified for the row clicked (i.e., it is a blank row), the 902 new date popup will first be initiated. If there has been a result previously entered in the selected cell, the test will be pre-selected within the test selection box 1004 and its value pre-filled into the results entry field. To enter a test result, the patient chooses a test within selection box 1004 by clicking on selection button 1006 and selecting a test from a drop-down selection list of defined tests. The patient chooses a test date within selection box 1008 by clicking upon the selection button 1010 and choosing a date from the set of defined test dates, defined as described with respect to FIG. 9. Once a test and date are selected, the patient may enter a test result value in text box 1012. The test result may be saved by clicking on “OK” button 1014 or the entered test pop-up window can be closed without saving the results by clicking upon cancel button 1016.

It should be noted that the flow sheet provides guidance information to the patient as shown in FIG. 10 at 1028 and 1030. Pop-up window 1002 performs dynamic range checking upon test result values having been entered into result box 1012, and will flash a message, such as “low” or “high” upon determining that the value entered is below or above the indicated low and high parameters defined for the test (See FIG. 6 at 610 and 612). Further, as shown at 1030, the test window displays test description information associated with the defined test (See FIG. 6 at 614). A set of navigation buttons 1018 are used to navigate between tests and between test dates. Clicking up arrow 1022 or down arrow 1026 allows a patient to advance or retard the selected date. Clicking upon left arrow 1020 or right arrow 1024 allows the patient to select a defined test that has been added to the flow sheet. In this manner, a patient is able to effectively populate the tests assigned to the flow sheet, and automatic dynamic range checking minimizes the entry of erroneous test result data.

FIG. 11 illustrates, by way of example, the patient flow sheet 202/1102 first presented in FIG. 2 as it appears once tests, test types and test result data have been defined and entered into the patient flow sheet, as described above. For example, the patient name entered through the patient name pop-up window 402 described with respect to FIG. 4, is represented in the flow sheet in row two at 1104. Test types defined using the new test type window 702 described with respect to FIG. 7 are represented in row three of the flow sheet at 1106. Individual tests are shown below a defined test type with which the test has been associated. Individual tests short names and test full names entered using the add/update test pop-up window 602/802 described with respect to FIGS. 6 and 8 are represented in rows four and row five, respectively, at 1108 and at 1110. Row seven and row eight at 1112 and at 1114, respectively, present the low and high values defined with respect to each defined test. Individual test result entries are shown in rows eleven through fourteen at 1116. Each test result entry, entered as described with respect to FIG. 10, is stored in an individual cell, associated by row with a date upon which the test was performed, below the test name.

Entered values that are above, or below, the high and low values defined for a test, as described with respect to FIGS. 6 and 8, are flagged to the patient as low (L) or high (H) values, as shown at 1118 and 1120, respectively. Test result values that are greater than a defined high value for a test or lower than a defined low value for a test (i.e., an out of range test result value) can be brought to the attention of the patient by applying a visual alert, or combination of visual alerts, to cells within the patient flow sheet that contain out of range values. Such visual alerts can include text indicators (e.g., (L), (H), “*,” “!!!,” etc.) and/or modified color/video parameters applied to the cell or text within the cell (e.g., colored characters, flashing characters, reverse video, modified cell background color, etc.). Any effect that draws the patient's attention to cells containing out of range values can be used. Further, different visual effects, or combinations of visual effects, can be applied to cells based upon the nature of the out of range value (i.e., whether the value is above a defined test maximum or below a defined test minimum) and the magnitude of the difference between the out of range value and the test threshold value that it exceeds).

The populated flow sheet illustrated in FIG. 11 provides an easy way for a patient to review defined test types, defined tests, test/test-type relationships and test result values entered into the flow sheet, as described above. High and low threshold parameters are associated with each test and entered test result values that exceed the threshold parameters are clearly flagged to the patient. In this manner, a patient is able to review the association of tests with test types and review entered test result values. Relationships between tests and test types can be updated based upon the patient's review of the populated flow sheet using the same pop-up windows accessed and used, as described above.

Further, a patient can edit test result entries by clicking on a test result value within the flow sheet to invoke the enter test result pop-up window 1002, described previously with respect to FIG. 10. As shown in FIG. 12, clicking upon a populated data entry in the patient flow sheet results in presentation of the enter test result pop-up window 1202, populated with the current test result values of the selected cell. A patient can change the value displayed in text box 1204 and save the change by clicking on “OK” button 1206. Further, the patient can proceed to navigate and update other incorrect test result entries using navigation buttons 1208, as described with respect to FIG. 10. Once the patient is satisfied with the test types, tests, and test result values entered into the patient flow sheet, the patient can proceed to print tabular reports and view charted reports based upon the defined tests and entered results data contained within the updated patient flow sheet.

FIG. 13 illustrates, by way of example, a Print Selection pop-up window 1302 used to select tests associated with a patient flow sheet for printing. The print selection pop-up window 1302 operates in a manner similar to the pop-up window used to associate defined tests with the flow sheet described with respect to FIG. 5, above. Tests available for printing are displayed in window 1304 based upon the test type selected in box 1306. Tests are selected for printing by selecting one or more tests from display window 1304 and adding the selected tests to window 1308 by pressing the add button at 1310. Selected tests can be deselected by selecting a test from window 1308 and pressing the delete button at 1312, thereby returning the test to window 1304 (i.e., tests not being printed). Date selection box 1314 and date selection box 1316 are used to specify a range of dates for which test results are to be printed for the selected tests. If the patient wishes to print test results associated with all test dates, all dates button 1318 is selected. The patient can set the page orientation of the printed report to landscape mode at 1320 or to portrait mode at 1322. When satisfied with the selected tests, date range, and page orientation, the patient can initiate the printing of reports by clicking on print button 1324, resulting in the presentation of a print preview screen that includes tabular reports generated for the selected tests. Upon viewing and/or printing the generated tabular reports, a patient exits print selection pop-up window 1302 by clicking upon done button 1326.

FIG. 14 illustrates, by way of example, a print preview screen 1402 that is displayed upon selecting print button 1324 in FIG. 13, as described above. The print preview window presents generated tabular reports in a specified tabular report order, as described below. A patient can zoom in on the generated reports by clicking on zoom button 1404, can adjust the setup of the report by clicking on setup button 1406, modify report margins by clicking on margins button 1408, or return to a standard formatted print preview, thereby undoing any previously made changes to the print preview format, by clicking on normal view button 1410. When satisfied with the appearance of the tabular reports, the patient can print the set of generated reports by clicking on print button 1412. Alternatively, the patient can close the print preview screen by clicking on close button 1414 or jump to a previous or next generated tabular report by clicking on next button 1418 to access the next tabular report or by clicking on previous button 1420 to access a previously viewed generated tabular report. Context sensitive help is available via help button 1416.

FIG. 15 illustrates, by way of example, specify sort order pop-up screen 1502 used to determine the order in which tabular and graphic charts are generated/displayed to the patient. A patient can specify the order in which test types and individual tests are presented.

To specify the order in which test types are presented, a patient clicks upon a test type displayed in window 1504 and clicks move up button 1506 or move down button 1508 to change the order of the selected test with respect to the other tests listed in display window 1504. Likewise, a patient clicks upon a test displayed in window 1510 and clicks upon move up button 1512 or move down button 1514 to change the order of the selected test with respect to the other tests listed in test display window 1510. A reporting order can be applied to both viewed reports and printed reports by specifying a sort order, as described above, with all tests button 1516 selected. Alternatively, individual sort orders can be established for viewing and printing separately by specifying a sort order, as described above, while one of viewing button 1518 and printing button 1520 is selected, respectively.

FIG. 16 illustrates, by way of example, a generate graphic report pop-up window 1602 used to select tests, select a test date range and to initiate generation chart reports. As shown in pop-up window 1602, a patient first selects a test via selection box 1604 and selects a start date and end date using selection box 1606 and 1608, respectively. Alternatively, a patient can select all dates for inclusion in the generated chart report by clicking on all dates button 1610. Upon clicking print button 1612, the patient is presented with a new workbook worksheet containing the generated chart report.

FIG. 17 illustrates, by way of example, a chart report worksheet 1702 used to display a generated chart report 1704. The chart report presents a graphical chart for the selected test. Although a graphical report can be presented in any graphical format (i.e., bar charts, line charts, etc.), typically a graphical value is presented in the report that represents each test result value within the specified range of dates specified for the selected test. The chart highlights results for specific tests on specific dates that fall outside the predefined normal ranges using different colors. In the example 1702, normal results are shown in green and abnormal results are shown in red. The patient can generate additional graphical reports by using generate graphic report pop-up window 1602 to select alternate tests and/or alternate date ranges and regenerating the graphical report by clicking on print button 1618.

As described above, the patient flow sheet in accordance with the present invention provides a patient with the ability to organize, view and analyze test results from multiple batteries of tests over time. The test results are generally received by the patient from his/her physician or from the testing laboratory. The test result data received by the patient is typically in hard copy format. However, the physician or lab may supply the data electronically, either via a removable storage media (e.g., floppy disk) or via electronic transmission (e.g., via the Internet), to permit direct entry into the patient's flow sheet.

In addition, the patient flow sheet provides a patient with links to information that is relevant to the patient's disease and/or course of treatment. A worksheet, stored within the same workbook as the patient flow sheet, that has been configured with links to locally and/or remotely stored information likely to be of interest to the patients suffering from multiple myeloma, is presented in FIG. 18. Information links are typically loaded into the patient flow sheet workbook prior to distribution of the patient flow sheet workbook to a patient. In this manner, the patient flow sheet can be customized with links of specific interest to the group of patients for which the patient flow sheet distribution is intended. Added links can be further tailored to include information, links and other indicia related to sponsors who have supported the development and distribution of the flow sheet product.

For example, a copy of the patient flow sheet organizer distributed to patients undergoing treatment for myeloma cancer can be distributed by the International Myeloma Foundation preconfigured with information and links to topics of interest to myeloma patients. Further, each flow sheet distribution can be preconfigured with information, links and indicia related to the organization distributing the flow sheet and well as information, links and indicia related to sponsors who have supported the distributing organization.

The links can be to static information sources that are included within the distribution of the patient flow sheet and/or links to information that is only accessible when the computing device executing the patient flow sheet is connected to a network containing the linked information sources.

As shown in FIG. 18, links and/or locally stored information to which the links are directed can be updated by clicking upon update links button 1804 when connected to an external network containing resource updates (such as the Internet) or when loaded with a distributed media, such as a CD or floppy, containing link updates. In one embodiment, clicking upon update links button 1804 updates information associated with existing local links and/or adds additional local and/or remote links based upon information stored at a URL maintained by the distributing organization (e.g., the International Myeloma Foundation).

For example, the information link worksheet included with the patient flow sheet, as shown in FIG. 18, includes information about the organization that compiled the information sources at 1806 and links to subject matter of interest to the patient at 1808. Thus, a patient is able to easily navigate between his personal course of treatment test results data, tabular and graphical visual representations of his personal test results data and information sources that are relevant to his treatment. In this manner, the patient is able to make optimum use of the information sources available to him (e.g., developments in the treatment of his specific disease, ongoing support group resources and activities, etc.) and take steps to optimize the patient's personal course of treatment and lifestyle.

It may be appreciated that the embodiments described above and illustrated in the drawings represent only a few of the many ways of implementing method and apparatus for capturing and analyzing individual patient clinical data. The present invention is not limited to the specific patient flow sheet embodiment described herein, but may be used to support any patient clinical data analysis tool that organizes and manages clinical data as described herein.

The patient flow sheet capability of the present invention can be implemented in any number of modules and is not limited to any specific software or hardware architecture. Each module can be implemented in any number of ways and is not limited in implementation to execute process flows precisely as described above. The patient flow sheet described above and illustrated in the flow charts and diagrams may be modified in any manner that accomplishes the functions described herein. It is to be understood that various functions of the patient flow sheet may be distributed in any manner among any quantity (e.g., one or more) of hardware and/or software modules or units, computer, network components or processing systems or circuitry.

It is to be understood that the software of the patient flow sheet may be implemented in any desired computer language, and could be developed by one of ordinary skill in the computer and/or programming arts based on the functional description contained herein and the flow charts illustrated in the drawings. For example, in one embodiment the patient flow sheet can be written as a stand-alone application in the C+ programming language, however, the present invention is not limited to being implemented in any specific programming language. Moreover, the patient flow sheet software may be available or distributed via any suitable medium (e.g., stored on devices such as CD-ROM and diskette, downloaded from the Internet or other network (e.g., via packets and/or carrier signals), downloaded from a bulletin board (e.g., via carrier signals), or other conventional distribution mechanisms).

The patient flow sheet software may be installed and executed on a computer system in any conventional or other manner (e.g., an install program, copying files, received via an existing network connection, downloaded, etc.). As noted above, direct entry of test result data in electronic format may be effected via removable media (e.g., floppy disk, CD-ROM, etc.) or electronic transmission (e.g., via the Internet) from a physician or testing laboratory.

The patient flow sheet may accommodate any quantity and any type of data set files and/or databases or other structures containing patient flow sheet or links to related information in any desired format (e.g., ASCII, plain text, HTML, any word processor or other application format, etc.).

Further, any references herein to software performing various functions generally refer to processors performing those functions under software control. Such processors may alternatively be implemented by hardware or other processing circuitry. The various functions of the patient flow sheet may be distributed in any manner among any quantity (e.g., one or more) of devices, hardware and/or software modules or units. Processing systems or circuitry, may be disposed locally or remotely of each other and communicate via any suitable communications medium (e.g., hardwire, wireless, etc.). The software and/or processes described above and illustrated in the flow charts and diagrams may be modified in any manner that accomplishes the functions described herein.

From the foregoing description it may be appreciated that the present invention includes a patient flow sheet that is capable of significantly improving the ability of individuals assess the effectiveness of their treatment and to access information relevant to making an informed decision about their treatment.

Having described preferred embodiments of a method and apparatus for capturing and analyzing individual patient clinical data, it is believed that other modifications, variations and changes may be suggested to those skilled in the art in view of the teachings set forth herein. It is therefore to be understood that all such variations, modifications and changes are believed to fall within the scope of the present invention as defined by the appended claims.

What is claimed is:

1. A method permitting medical patients to periodically enter into a computer and view test result data from the patient's medical tests and to readily analyze the history of and trends in the data over periods of time, said method comprising the steps of:
(a) defining predetermined tests performed on the patient;
(b) categorizing said predetermined tests into defined test types;
(c) creating a flow sheet having an array of data cells for receiving test data, said array being dividable into portions and sub-portions of said portions;
(d) assigning said portions of said array to respective defined test types;
(e) assigning said predetermined tests to sub-portions of the array portions assigned to the defined test type into which the predetermined tests are categorized in step (b);
(f) entering into the computer test result data from medical test performed on the patient;
(g) allocating the test result data entered in step (f) to appropriate tests of said predetermined tests;
(h) entering into the computer date of test information for the test result data entered in step (f);
(i) transferring the data entered in step (f) to sub-portions of said array assigned to said appropriate tests for the entered data and labeling the transferred data on said flow sheet with said date of entry information;
(j) selectively displaying on said flow sheet the entered test result data and positioning the displayed test result data in said portions and sub-portions assigned to the defined test types and predetermined tests to which the test result is allocated; and
(k) displaying along with the test result data displayed in step (j) the date of test information entered in step (h) for the displayed test result data;
whereby the display on the flow sheet presents a visual history by date of test of all of the displayed test results for each predetermined test.

2. The method of claim 1 further comprising the step of:
(l) inhibiting display of test result data in step (j) unless and until date of test information for that test result data has been entered in step (h)

3. The method of claim 2 further comprising the steps of:
(m) establishing for at least some of said predetermined tests at least one range bounding value of test result data; and
(n) providing on said flow sheet a visual out of range indication for each displayed test result value that is beyond said range-bounding value.

4. The method of claim 2 further comprising the steps of:
(m) establishing for at least some of said predetermined tests an upper normal range value and a lower normal range value; and
(n) providing on said flow sheet a visual out of range indication for each displayed test result value that exceeds said upper normal range value or is less than said lower normal range value.

5. The method of claim 4 wherein step (n) comprises providing an identifiable color in a data cell.

6. The method of claim 5 wherein step (c) comprises creating said array in the form of a matrix of columns and rows of said data cells.

7. The method of claim 6 wherein:
step (d) comprises allocating said portions of said array to respective groups of columns of said matrix;
step (e) comprises allocating sub-portions of said array portions to respective columns in the a group of columns; and
step (j) comprises displaying test result data for each date of test in a common row of said matrix.

8. The method of claim 1 further comprising the steps of:
(m) establishing for at least some of said predetermined tests an upper normal range value and a lower normal range value; and
(n) providing on said flow sheet a visual out of range indication for each displayed test result value that exceeds said upper normal range value or is less than said lower normal range value.

9. The method of claim 8 wherein step (n) comprises providing an identifiable color in at least one of a data cell, report cell and graphical chart bar.

10. The method of claim 1 wherein step (c) comprises creating said array in the form of a matrix of columns and rows of said data cells.

11. The method of claim 10 wherein:
step (d) comprises allocating said portions of said array to respective groups of columns of said matrix;
step (e) comprises allocating sub-portions of said array portions to respective columns in the a group of columns; and
step (j) comprises displaying test result data for each date of test in a common row of said matrix.

12. A computer apparatus for organizing personal test results for a medical patient for viewing and analysis:
a patient flow sheet module for building a flow sheet containing an array of data cells configured to receive information pertaining to a plurality of tests;
a test type definition module for selectively defining at least one defined test type;
a test definition module for selectively defining a plurality of specified tests and associating each specified test with one of said defined test types;
a test selection module for selecting a plurality of specified tests and assigning the specified tests to the patient flow sheet, thereby defining a prescribed battery of tests within the flow sheet; and
a date-of-test module for associating a test date with said prescribed battery of tests.

13. The apparatus of claim 12 further comprising:
means for initially inhibiting entry of test results into the patient flow sheet; and
means responsive to said date-of-test module associating at least one test date with each prescribed battery of tests for enabling entry of test results for said each prescribed battery of tests into the patient flow sheet.

14. A computer apparatus for organizing personal test results for a medical patient for viewing and analysis:
a patient flow sheet module for permitting the patient to build a flow sheet containing an array of data cells configured to receive information pertaining to a plurality of tests;
a test type definition module for permitting the patient to define at least one defined test type;
a test definition module for permitting the patient to define a plurality of specified tests and associate each specified test with one of said defined test types;
a test selection module for permitting the patient to select a plurality of said specified tests and assign the selected specified tests to the patient flow sheet, thereby defining a prescribed battery of tests within the flow sheet; and
a date-of-test module for permitting the patient to associate a test date with said prescribed battery of tests for entry into the data cells of said flow sheet.

15. A method for organizing, in a computer, personal test results for a medical patient for viewing and analysis, said method comprising the steps of:
(a) providing an empty flow sheet for receiving information;
(b) defining at least one defined test type;
(c) establishing a plurality of specified tests and associating each of the plurality of specified tests with said defined test types;
(d) assigning a plurality of specified tests to the empty flow sheet to thereby define a prescribed battery of tests within the flow sheet;
(e) associating a date of test with said prescribed battery of tests; and
(f) entering test result data for said prescribed battery of tests for each date of test associated with the prescribed battery of tests.

16. The method of claim 15 further comprising the step of inhibiting the entering of result data in step (f) unless and until a date of test is associated with the prescribed battery of tests for the data to be entered.

17. The method of claim 15 further comprising the step of directing the patient to the next logical step in the method by enabling only options that are applicable to the step in the method currently being performed.

18. The method of claim 15 further comprising the step selectively providing graphical chart displays of test result data entered in step (f) for any of said specified tests as a function of date of test.
